(19) United States
(12) Patent Application Publication
(10) Pub. No.: US 2010/0026590 A1
(43) Pub. Date: Feb. 4, 2010

(54) THIN FILM MULTI-BAND ANTENNA

(76) Inventors: Kuo-Ching Chiang, Linkou Township (TW); Huei-Tung Ching, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/102,160

(22) Filed: Apr. 14, 2008

Related U.S. Application Data
(63) Continuation-in-part of application No. 10/900,766, filed on Jul. 28, 2004, now Pat. No. 7,388,549.

(51) Int. Cl. H01Q 1/22; H01Q 1/36; H01Q 1/32; H01Q 9/16; H01Q 1/52

(52) U.S. Cl. 343/702; 343/700 MS; 343/713; 343/793; 343/841; 977/742; 977/932

(57) ABSTRACT

The present invention discloses a multi-band antenna, especially a fractal antenna which allows a convenient reception of a signal for communication. The multi-band behavior is obtained by a set of geometry patterns of the same basic elements. The materials of the antenna may be formed by a chemical solution or a sputtering vacuum deposition process. An additional passivation layer can be added to protect the conducting layer of the antenna. Materials for this passivation layer are made, for instance, of oxide, or any other polymeric material, polymer, or resin coating on the structure.

### RELATED APPLICATIONS

The present application is a Continuation-In-Part (CIP) of a co-pending application entitled Multi-band antenna, U.S. Ser. No. 10/900,766, filed Jul. 28, 2004, which is hereby fully incorporated herein by reference.

### FIELD OF THE INVENTION

The present invention relates an antenna, and more particularly, a multi-band transparent antenna coated on an object.

### BACKGROUND OF THE INVENTION

Recently, wireless telecommunication has become widespread in the world. Most of the wireless devices such as portable phone, personal assistance and digital television need a receiving apparatus to receive the transmission signal. Owing to digitization of information signals, various types of information such as audio information, image information, etc. can be easily handled on personal computers, mobile devices, etc. Audio and image codec technologies are used to promote the band compression of these types of information. Digital communication and digital broadcasting are creating an environment to easily and efficiently deliver such information to various communication terminal devices. For example, audio video data (AM data) can be received on a portable telephone.

The wireless communication module is attached to or detached from the main device via the connector to store data and the like supplied from the main device in the flash memory element and transfer data and the like stored in the flash memory element to the main device. When attached to the main device, the wireless communication module uses the externally protruded antenna section to enable wireless interchange of signals between the main device and a host device or a wireless system. RF circuits, transmission lines and antenna elements are commonly manufactured on specially designed substrate boards. For the purposes of these types of circuits, it is important to maintain careful control over impedance characteristics. Electrical length of transmission lines and radiators in these circuits can also be a critical design factor. Two critical factors affecting the performance of a substrate material are dielectric constant (sometimes called the relative permittivity) and the loss tangent (sometimes referred to as the dissipation factor). The relative permittivity determines the speed of the signal in the substrate material, and therefore the electrical length of transmission lines and other components implemented on the substrate. The loss tangent characterizes the amount of loss that occurs for signals traversing the substrate material. Losses tend to increase with increases in frequency.

Printed transmission lines, passive circuits and radiating elements used in RF circuits are typically formed in one of three ways. One configuration known as micro-strip, places the signal line on a board surface and provides a conductive layer, commonly referred to as a ground plane. A second type of configuration known as buried micro-strip is similar except that the signal line is covered with a dielectric substrate material. In a third configuration known as strip-line, the signal line is sandwiched between two electrically conductive (ground) planes. The antenna is patterned on a principal plane of the printed circuit board. For vehicle application, the most common solution for these systems is the typical whip antenna mounted on the car roof The current tendency in the automotive sector is to reduce the aesthetic and aerodynamic impact due to these antennas by embedding them in the vehicle structure. Also, a major integration of the several telecommunication services into a single antenna would help to reduce manufacturing costs.

Some references related to the antenna configuration, for example: A design optimization methodology for multi-band stochastic antennas, P. L. Werner et al., 2002 IEEE, pp. 354-357. Hexagonal Fractal Multi-band Antenna, Philip Tang, 2002, IEEE, 554-556. Compact Multi-band Planar Antenna for Mobile Wireless Terminals, Zygmond Turski et al., IEEE, 2001, pp. 454-457. Trapezoidal Sierpinski Multi-band Fractal Antenna With Improved Feeding Technique, C.T.P. Song, IEEE, Transaction on Antenna and Propagation, vol. 5, No. 5, May 2003, pp, 1011-1017. Design of an Internal Qual-Bend Antenna for Mobile Phone, Pascal Ciais et al., IEEE, Microwave and Wireless Components Letters, vol. 14, No. 4, April, 2004, pp. 148-150. Design of a Multi-band Internal Antenna for Third Generation Mobile Phone Handsets, Mohammod Ali et al., IEEE, Transaction on Antenna and Propagation, vol. 51, No. 7, July 2003, pp, 1452-11461. Fractal Multi-band Antennas Based on Lotus-pods Patterns, Ji-Chyun Liu et al., Proceedings of APMC2001, Taipei, Taiwan, R.O.C., 2001 IEEE, pp. 1255-1258. Fractal Design of Multi-band and Low Side-Lobe Arrays, Carles Puente-Baliarda, IEEE, Transaction on Antenna and Propagation, vol. 44, No. 5, May 1996, pp, 730-739. U.S. Pat. No. 445,884 proposed to use the entire windshield conductive layer as impedance matching for FM band substantially horizontal antenna element. U.S. Pat. No. 6,300,914 proposes an antenna formed from some elementary fractal elements. A base element is shown as a straight line, although a curve could be used instead. A so-called Koch fractal motif or generator is inserted into base element to form a first order iteration (“N”) design, e.g., N=1. A second order N=2 iteration design results from replicating the triangle motif into each segment, but with reduced size. As noted in the Lauwerier treatise, in its replication, the motif may be rotated, translated, scaled in dimension, or a combination of any of these characteristics. A higher order pattern has been generated by including yet another rotation, translation, and/or scaling of the first order motif One well known treatise in this field is Fractals, Endlessly Repeated Geometrical Figures, by Hans Lauwerier, Princeton University Press (1991), which treatise applicant refers to and incorporates herein by reference. U.S. Pat. No. 6,642,898 discloses a fractal cross slot broad band antenna comprising a radiating fractal cross slot layer having a plurality of antennas each comprising a plurality of radiating arms.

Obviously some of the antenna configurations can only operate at a determinate frequency band by reason of the frequency dependence of the antenna parameter and are not suitable for a multi-operation. The material for the antenna is metal or alloy which will reduce the visibility if it formed on glass.

### SUMMARY OF THE INVENTION

The present invention relates an antenna with the following parts and features. A transparent window is partially coated with a transparent conducting pattern. Two-conductor feeding transmission line and an impedance at the feeding point. The antenna is capable of receiving at least one of the bands: FM, PHS, Wireless car aperture, GSM900, GSM1800, CDMA, GPRS, Bluetooth and WLAN, and digital TV band.

The present invention discloses an antenna comprising: a transparent conductive pattern formed on a glass, wherein the pattern includes antenna configuration; and a power source for moisture removal is coupled to the antenna configuration for providing heat or power to the transparent conductive pattern for removing fog, moisture on the glass. The antenna configuration includes a fractal antenna configuration such as Sierpinski pattern, koch pattern, Blackman-koch pattern, stochastic pattern, a set of hexagonal pattern, tree shape pattern or polygonal pattern. Further, the antenna configuration could be a monopole or dipole antenna configuration. The antenna configuration includes a trapezoidal planar antenna configuration.

The present invention discloses an antenna for an object comprising: at least one transparent conductive pattern attached at least partially on the object, wherein the transparent conductive pattern includes an antenna configuration that is preferable to select one or more from fractal, planar, monopole and dipole antenna configuration. The object includes a vehicle windshield or a vehicle rearview mirror, wherein the transparent conductive pattern is attached at least partially to the interior of the vehicle windshield or on the vehicle rearview mirror. Further, the object includes a substrate of a portable device. Wherein the object also includes, a vehicle rear light, a vehicle break light or a vehicle headlight. The transparent conductive pattern includes an oxide containing one or more following metals, wherein the metal is at least selected from Au, Ag, In, Ga, Al, Sn, Ge, Sb, Bi, Zn, Pt and Pd. The method for forming the conductive pattern comprises preparing a coating solution containing metal particles and then coating the solution on a substrate to form a layer; drying the layer; and baking the layer to obtain a transparent conductive pattern.

The present invention further discloses a conductive pattern comprising: a plurality of strips attached partially on an object, wherein the material for the conductive pattern includes an oxide containing metal, the metal being preferable to select one or more metals from the aforementioned group, a power source coupled to the conductive pattern for providing electrical current flowing through the conductive pattern to remove fog or moisture on the object. The object includes windshield of a vehicle, window, and rearview mirror of a vehicle, or glass, portable device such as cellphone, notebook computer, personal data assistance and so on.

The advantage of the invention is the multi-band behavior of the antenna, especially the fractal antenna which allows convenient reception of a signal for communication. The multi-band behavior is obtained by a set of geometry patterns of the same dimension. The transparent materials may be formed by a sputtering vacuum deposition process. An additional passive layer can be added to protect the conducting layer. Materials for this passivation layer are made, for instance, of an oxide, or any other polymeric material, polymer, resin coating on the structure. The method for forming the transparent conductive layer includes an ion beam method at low temperature, see 1999, IEEE, 1191. U.S. Pat. No. 6,743,476 discloses a method of producing a thin film electrode at room temperature. Both the ion beam and sputter processes are expensive. During the formation process, the present invention suggests that a mask can be placed on the substrate material to obtain the desired multi-band antenna shape. This mask normally is made of conducting material such as stainless steel or copper, or a photosensitive material to create the mask by photochemical processes. Then, the pattern can be “print” on the desired object. Thus, the expensive sputter process can be replaced by the chemical solution coating.

An antenna system includes a driven element, and at least one element a portion of which is a fractal element selected from a fractal counterpoise element. Wherein the fractal element is superposition over at least N=1 iterations of a fractal generator motif. An iteration is placement of the fractal generator motif upon a base figure through at least one positioning selected from the group consisting of (i) rotation, (ii) stretching, and (iii) translation.

The antenna comprises a conductive pattern having an antenna configuration, wherein said conductive pattern is formed of conductive carbon, a conductive polymer or conductive glue having glass and conductive particles. The conductive pattern includes one or more particles selected from Au, Zn, Ag, Pd, Pt, Rh, Ru, Cu, Fe, Ni, Co, Sn, Ti, In, Al, Ta, Ga, Ge and Sb. The conductive carbon includes CNT. The conductive polymer includes polythiophenes, poly(selenophenes), poly(tellurophenes), polypyrroles, polyanilines. The conductive glue includes glass, conductive particles, additive. The glass is selected from Al₂O₃, B₂O₃, SiO₂, Fe₂O₃, P₂O₅, TiO₂, B₂O₃/H₃BO₃/Na₂B₄O₇, PbO, MgO, Ga₂O₃, Li₂O, V₂O₅, ZnO₂, Na₂O, ZrO₂, TlO/Tl₂O₃/TlOH, NiO/Ni, MnO₂, CuO, AgO, Sc₂O₃, SrO, BaO, CaO, Tl and ZnO.

The antenna pattern includes fractal antenna configuration, monopole, dipole antenna configuration, battlements shape, trapezoidal planar antenna configuration, and inverted F configuration.

The conventional antenna is attached on the printed circuit board (PCB) of the device. However, the signal and EM waves generated by the antenna and the PCB will interrupt each other. Therefore, one aspect of the present invention is to remove the antenna from the PCB in order to eliminate the interference. In the embodiment, the antenna is formed on an interior or exterior surface of a housing of an electronic device having a printed circuit board, wherein a shielding structure is disposed between said antenna and said shielding structure; wherein said antenna has a conductive pattern, and is formed of metallic material, conductive carbon, a conductive polymer or conductive glue having glass and conductive particles.

### BRIEF DESCRIPTION OF THE DRAWINGS

FIG. 1A describes a general example of the antenna attached on the windshield.

FIG. 1B illustrates the multilevel antenna formed between a substrate and a passivation layer.

FIGS. 1C-1G illustrate the multilevel antenna formed on an object.

FIG. 2A shows a rectangular multilevel structure as a monopole antenna.

FIG. 2B shows a peak shape as a motif element for a multilevel structure.

FIG. 2C shows a hexagonal element as a motif element for a multilevel structure.

FIG. 2D shows a triangle as a motif element for a multilevel structure.

FIG. 2E shows a circle as a motif element for a multilevel structure.

FIG. 2F shows a stochastic pattern for a multilevel structure.

FIG. 2G illustrates the battlements shape antenna.

FIG. 2H illustrates the tree shape pattern.

FIG. 2I illustrates the trapezoidal planar antenna configuration.

FIG. 2J illustrates the square antenna configuration.

FIG. 3 illustrates the flow of forming the antenna according to the present invention.

FIGS. 4A and 4B illustrate the antenna arrangement for the portable device.

### DETAILED DESCRIPTION OF THE PREFERRED EMBODIMENTS

The present invention describes a multi-band antenna for a vehicle or a portable device. A configuration of the antenna pattern includes a set of polygonal elements, all of them of the same class (the same number of sides like), wherein the polygonal elements are electromagnetically coupled either by means of an ohmic contact or a capacitive or inductive coupling mechanism. The antenna configuration can be composed by whatever class of polygonal elements (triangle, square, pentagon, hexagon or even a circle or an ellipse in the limit case of infinite number of sides) as long as they are of the same class. The present invention differs from a conventional shape and the material to form the antenna. The antenna structure is easily identifiable and distinguished from a conventional structure by identifying the majority of elements and the material which constitute it. The main advantage addressed by fractal-shaped antennas antenna were a multi-frequency behavior, that is the antennas featured similar parameters (input impedance, radiation pattern) at several bands maintaining their performance. Also, fractal-shapes permit obtaining an antenna of reduced dimensions compared to other conventional antennas. The antenna structure is based on multi-order structure with motif elements, such as polygonal structures, peak shape, circles, and tree shape. In the present invention, the concepts of fractals are applied in designing antenna elements and arrays. It is possible to use fractal structure to design small size, low profile, and low weight antennas. Most fractals have self-similarity, so fractal antenna elements or arrays also can achieve multiple frequency bands due to the self-similarity between different parts of the antenna. The combination of the infinite complexity and detail plus the self-similarity which are inherent to fractal geometry, makes it possible to construct smaller antennas with very wideband performance. A fractal loop antenna is about 5 to 10 times smaller than an equivalent conventional wideband low frequency antenna.

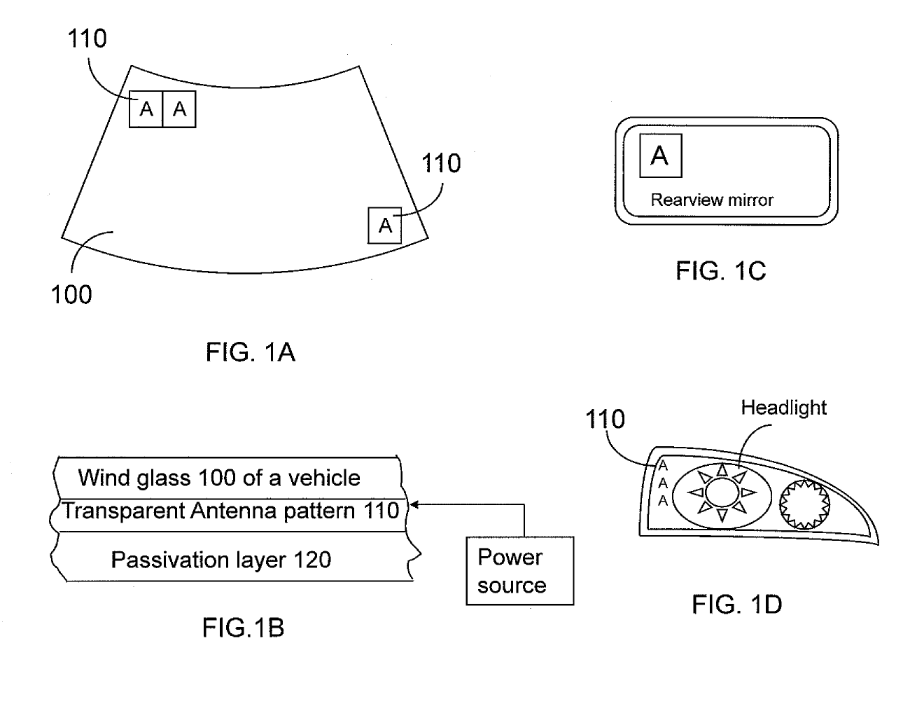

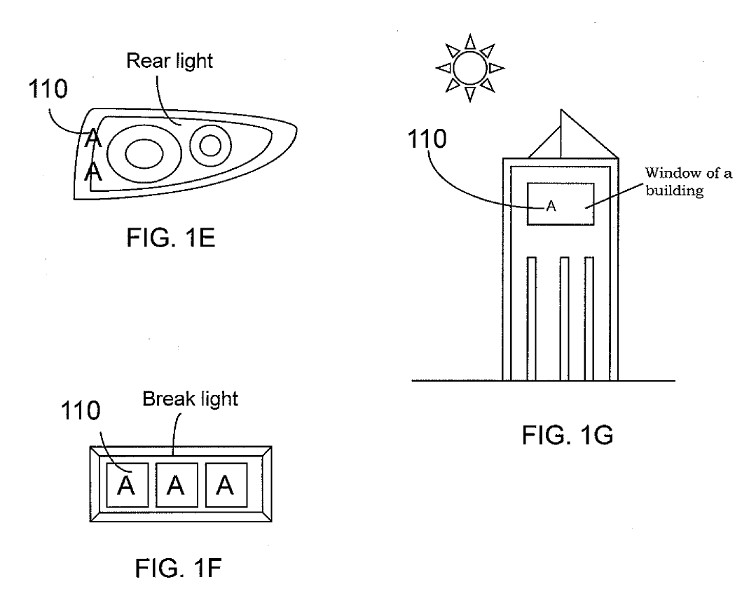

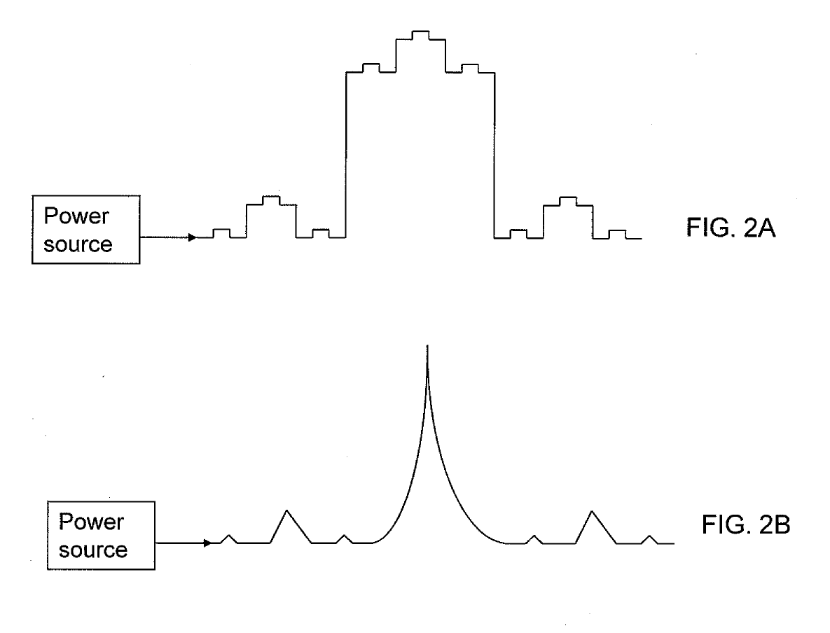

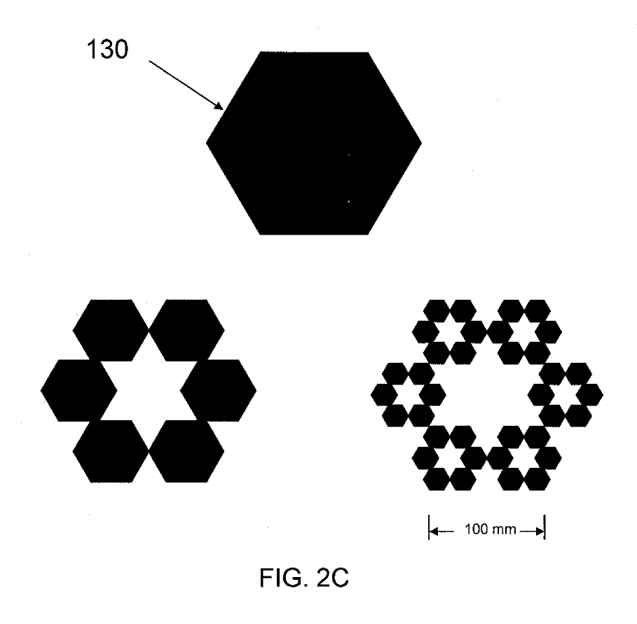

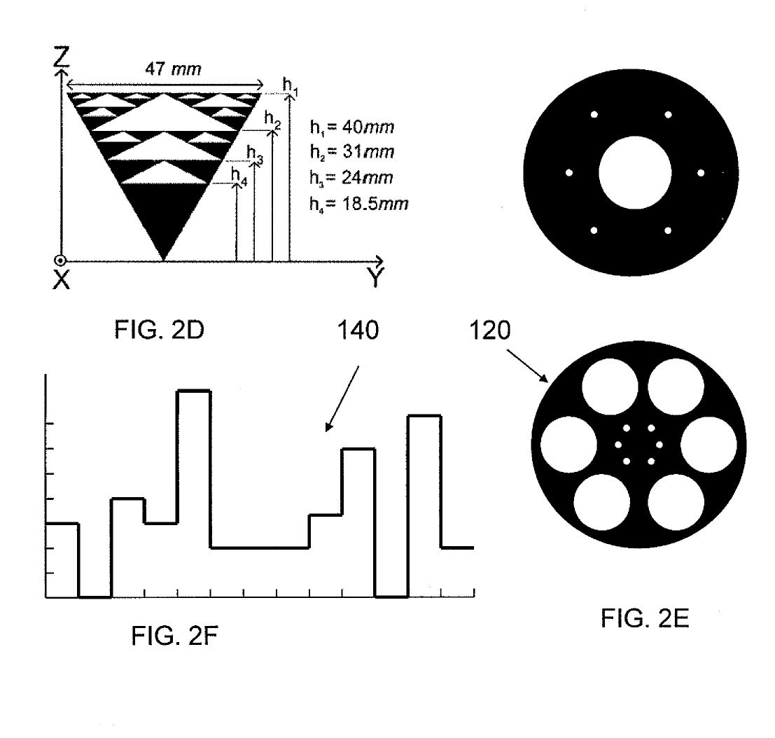

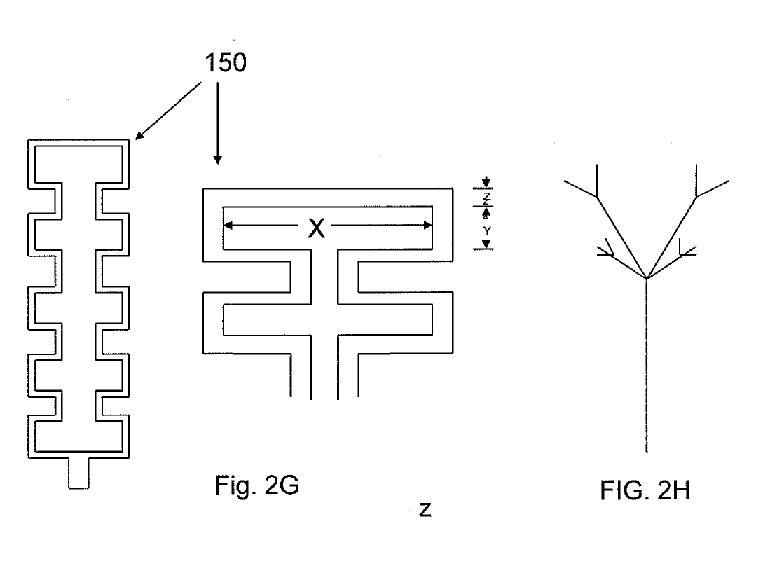

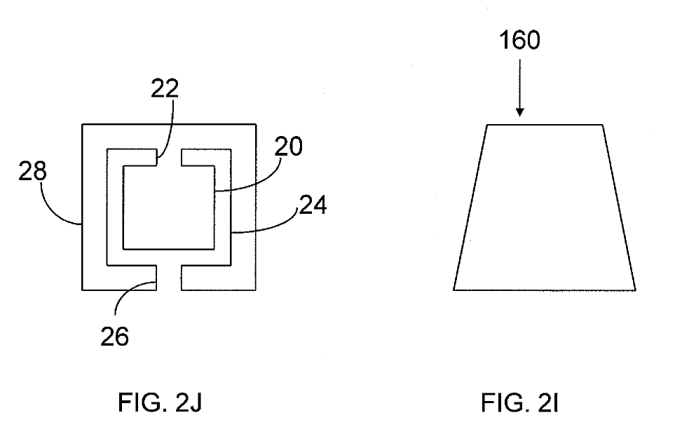

FIGS. 1A and 1B describe a preferred embodiment of the present invention, the present invention comprising: a transparent conductive pattern 110 formed on an object 100, a passivation layer 120 coated on the antenna pattern 110. One example of the object 100 is wind glass, rearview mirror of a vehicle (see FIG. 1C), window of a building (FIG. 1G), rear light of a vehicle (see FIG. 1E), vehicle head light (see FIG. 1D), rear light or vehicle break light (see FIG. 1F). It could also be formed in the rearview mirror encapsulate. The pattern includes an antenna configuration. In one example, a power source is optionally coupled to the antenna configuration for providing heat or power such that the transparent conductive pattern removes fog, moisture on the glass. The transparent antenna configuration includes a fractal antenna configuration. As known in the art, the fractal configuration with a base element. A motif is inserted into the base element to form a first order. A second order iteration results from replicating the motif into each segment. The shape or the configuration of the fractal antenna pattern could include a koch pattern (FIG. 2A), Blackman-koch pattern (FIG. 2B), the main feature of the koch pattern is that each lobe of the curve is equal to the whole pattern. When the array radiates at a longer wavelength, the visible range is reduced and only a fraction of the whole array factor appears in the radiation pattern. The array has a similar radiation pattern at several bands, the pattern magnitude reduced when the operating wavelength is increased. The modification of koch pattern is Blackman-koch pattern. In one example, the base element is rectangular shape. The motif is inserted into the rectangular shape to form a further order. A higher order iteration results from replicating the motif into each segment. Therefore, the Koch pattern is conformed with arrays constructed by interleaving hyperbolic distribution. The frequency reduction by a factor (⅓) would reduce the visible range around a secondary lobe which has the same shape as the whole pattern. An array factor for a set of bands spaced by a factor of ⅓. The Blackman-koch pattern includes a peak shape motif. A second order iteration results from replicating the motif into each segment.

The shape or the configuration of the fractal antenna includes a polygonal such as hexagonal pattern 130 (FIG. 2C), the hexagonal fractal antenna resonant frequencies repeat with a factor of three, whereas the Sierpinski pattern fractal antenna resonant frequencies repeat with a factor of two. Hexagonal pattern 130 allows more flexibility in matching multi-band operation. Sierpinski pattern is shown in FIG. 2D. The antenna presented in FIG. 2D approximates the shape of a Sierpinski triangle. Since multi-scale levels are included in this example, this configuration assures a similar antenna behavior at multi-frequency bands. Lotus-pods Patterns 120 (FIG. 2E) is another embodiment. The pattern includes a disk with a plurality of circles formed therein. For example, six circles circularly tangent to each other with radius. The disk is the first generator, whereas the smaller generator is constructed by the six circles constructing circular hexagon. From the figure, the pattern includes at least one kind of circle with one radius. Therefore, the Lotus-pods Patterns 120 are formed, in one example, the fractal scale is one third, and the multi-band response related to the iteration of fractal pattern is observed. The radius can be 65.2 mm. The antenna configuration could also be a monopole or dipole antenna configuration. As shown in FIG. 2F, a stochastic pattern 140 is illustrated. FIG. 2G illustrates the battlements shape antenna 150. The width of the battlements shape traces Z is about 1 mm, the width of one battlement (Y+2Z) is about 6 mm. The length of (X+2Z) is about 10 mm. The dimension is for example. The dipole antenna configuration includes a tree shape pattern (FIG. 2H). The order of the fractal could be determined as desired. Planar antenna configuration is another option for the design. One possible example is trapezoidal planar antenna configuration 160 (FIG. 2I). The pattern may reduce the lost of the antenna and broaden the operating bandwidth.

In another one example (FIG. 2C), this configuration is composed by a set of hexagonal elements. One to 30 or more hexagonal elements are used and the antenna features a similar behavior at multi different frequency bands. The configuration is fed with a two conductor structure as well known in the art, with one of the conductors connected to the lower vertex of the multilevel structure and the other conductor connected to the metallic structure of the car. The contact can be made directly or using an inductive or capacitive coupling mechanism to match the antenna input impedance. The feeding conductor transmission line is formed with, for example, a 300 Ohms, a 50 Ohms or a 75 Ohms transmission line. An optically transparent conductive pattern is attached on a transparent substrate like the window of a building, rearview mirror, or windshield of a vehicle. A windshield or any vehicle window in general is an adequate position to place this antenna such as a vehicle windshield, a vehicle rearview mirror, vehicle rear light, vehicle break light or vehicle headlight. The antenna is useful for receiving the incoming signals in a typical multi-band propagation environment. The antenna array is also a preferred arrangement. The present invention could be set on the window of a building to receive the communication signal. It may be coated on the glasses. Several multilevel structures can be printed with the same or different scheme described in any of the preceding configurations (FIGS. 2A-2J) or a combination of them, to form an antenna array or diversity scheme. The fractal multilevel structures are the same class with different size, scale or aspect ratio to tune the resonant frequencies to the several operating bands. The basic element of the multilevel antenna configurations includes line, polygonal structures (rectangular, hexagonal), peak shape, circles, and tree shape. Referring now to FIG. 2J, a fractal loop antenna includes a first substantially square shaped motif element 20 that is coupled to a second substantially square shaped motif element 22 via connection paths 24. The second substantially square shaped element 22 is also connected to a third substantially square shaped element 26 via connection paths 28. The pattern can be repeated indefinitely based on the number of loops.

The material for the conductive pattern includes oxide containing metal, wherein the metal can be selected one or more from Au, Ag, Pt, In, Ga, Al, Sn, Ge, Sb, Bi, Zn, and Pd. Some conductive materials formed by the method are transparent, if the antenna is attached on the glass or window, one may see through the window or glass. The antenna may also be attached on the light bulb cover of a vehicle. The transmittance of the cover is lower than the window, thus, the present invention may be formed on the light bulb cover of the vehicle. Alternately, the antenna could be formed on the cover, screen of the notebook, cell phone and so on.

In this case, the conductive layer, usually composed by a material including an oxide containing metal or alloy, wherein the metal is preferably one or more metals selected from Au, Zn, Ag, Pd, Pt, Rh, Ru, Cu, Fe, Ni, Co, Sn, Ti, In, Al, Ta, Ga, Ge and Sb. Some of the transparent material include oxide containing Zn with Al₂O₃ doped therein. This shape is constructed by using an adequate mask during the forming process of the transparent conducting layer. In the case, the inner coaxial cable is directly connected to the element of the conductive layer, which can be optionally connected to the metallic body of the car. Other feeding configurations are possible such as by using a capacitive coupling. The feeding mechanism is well known in the art. The reception system can be improved by using space-diversity or polarization diversity techniques. Two or several multi-band antennas or an antenna array can be used. The advantage of using the techniques described in the present invention is that attaching a plurality of antennas in the same transparent window such that the diversity scheme can be included at a low cost. The feeding scheme is well known by those skilled in the art, other configurations of multi-band antennas can be used as well within the same scope and spirit of the present invention. From FIG. 2, multi-band antennas defined by the pattern are presented. In each figure, the antenna is represented in the different configurations. The polygon-based structure can be chosen as an alternative shape whenever polarization diversity schemes are to be introduced to compensate the signal fading due to a rapidly changing propagation environment.

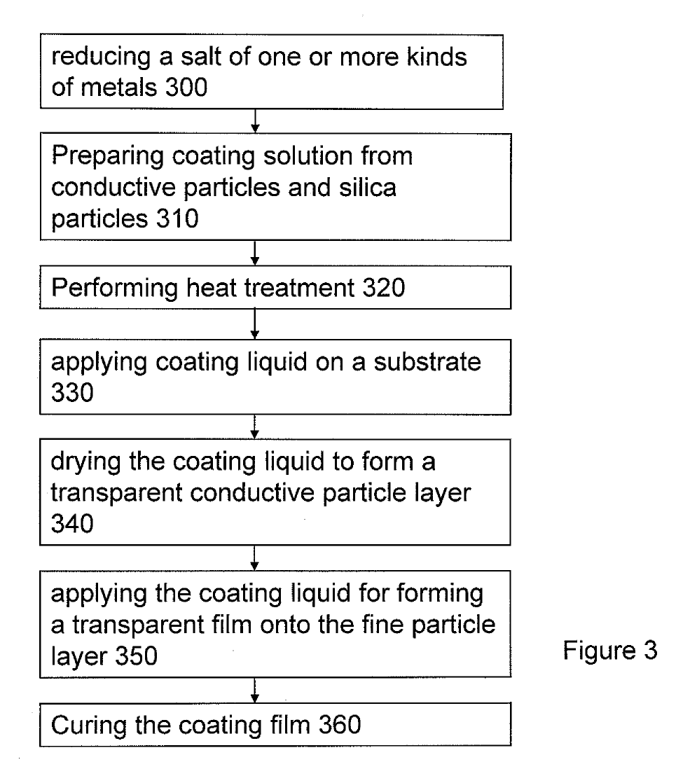

The method for forming the transparent conductive layer includes an ion beam method for film formation at low temperature. Another formation method is a chemical solution coating method, as shown in FIG. 3. The coating solution includes conductive particles (prepared in step 310) having an average particle diameter of 1 to 25 μm, silica particles having an average particle diameter of 1 to 25 μm, and a solvent. The weight ratio of the silica particles to the conductive particles is preferably in the range of 0.1 to 1. The conductive particles are preferably metallic particles of one or more metals selected from Au, Zn, Ag, Pd, Pt, Rh, Ru, Cu, Fe, Ni, Co, Sn, Ti, In, Al, Ta, Ga, Ge and Sb. The conductive particles can be obtained by reducing a salt of one or more kinds of the aforesaid metals in an alcohol/water mixed solvent (step 300). Heat treatment (step 320) is performed at a temperature of higher than about 100 degree C. to provide thermal energy for chemical reaction between the silica and metallic particles to form the transparent conductive coating solution. The silica particles may improve the conductivity of the resulting conductive film. The metallic particles are approximately contained in amounts of 0.1 to 5% by weight in the conductive film coating liquid.

The transparent conductive film can be formed by applying the liquid on a substrate (step 330), drying it to form a transparent conductive particle layer (step 340), then applying the coating liquid for forming a transparent film onto the fine particle layer to form a transparent film on the particle layer (step 350). The coating liquid for forming a transparent conductive layer is applied onto a substrate by a method of dipping, spinning, spraying, roll coating, flexographic printing or the like and then drying the liquid at a temperature of room temperature to about 90 degree C. After drying, the coating film is cured by heating at a temperature of not lower than 100 degree C. or irradiated with an electromagnetic wave or in the gas atmosphere (step 360) to harden the thin film and lower the resistance.

The present invention discloses fractal, monopole, dipole antenna configuration attached on at least one side of a window, glass or windshield. In the embodiment of a fractal antenna configuration, the structure is composed by a set of geometry pattern of the same class (the same number of sides or the same pattern dimension), being such that the set of geometry pattern electromagnetically coupled either by means of an ohmic contact or a capacitive or inductive coupling mechanism. One transmission line is coupled to a geometry pattern by means of either an ohmic contact or a capacitive or inductive coupling mechanism. The antenna features similar impedance at the feeding point in the multilevel bands. The geometry pattern is constructed and filled in the inside area of the geometry pattern, thereby forming a solid-shape structure with the transparent conducting material.

A moisture removal power source may be coupled to the antenna configuration via a transmission line for providing heat to the pattern to remove fog or moisture on the glass or window. Thus, in some case, the configuration includes dual functions including receiving a signal and acting as means for removing fog or moisture.

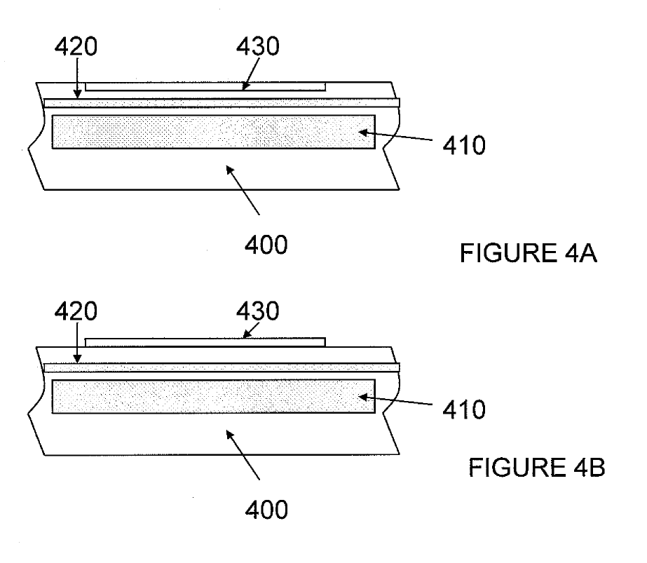

Alternatively, the material for forming the aforementioned embodiments includes conductive polymer, conductive carbon or conductive glue. The non-metal material is lighter weight, cost reduction and benefits simpler process. The conventional antenna is formed of copper or the like. The cost of the copper is high and it is heavy. On the contrary, the present invention employs the non-metallic material to act as the antenna to save cost and reduce weight. The formation of the conductive polymer, conductive carbon or conductive glue may be shaped or formed by printing (such as screen printing), coating, attaching by adhesion or etching. The process simpler than the conventional process. On the other hand, the thin film antenna can be attached or formed on an irregular surface or non-planner surface. The conventional antenna of the conventional portable device is embedded into a circuit board of the device, the shielding effect is an issue for consideration. However, the present invention may move the antenna out of the circuit board to the interior or exterior of the housing of the portable device to eliminate the shielding effect, thereby improving the reception or transmission of the signal. If the thin film antenna is transparent, the antenna may be attached on the screen of the display or window of a housing or vehicle. FIGS. 4A and 4B illustrate the cross-section views of a portable device. In one embodiment, the antenna 430 is attached on an interior surface of a housing of a portable device 400 (see FIG. 4B) or on an exterior surface of a housing of a portable device 400 (see FIG. 4A). A shielding 420 is disposed between the antenna 430 and the PCB 410 of the portable device. The shielding may prevent the interference between the antenna 430 and PCB 410.

In one embodiment, the antenna is formed of conductive carbon, such as carbon nanotubes (CNTs) that comprises multiple concentric shells and termed multi-walled carbon nanotubes (MWNTs), singe-walled carbon nanotubes (SWNTs) that includes a single graphene rolled up on itself, it being synthesized in an are-discharge process using carbon electrodes doped with transition metals. The seamless graphitic structure of single-walled carbon nanotubes (SWNTs) endows these materials with exceptional mechanical properties: Young's modulus in the low TPa range and tensile strengths in excess of 37 GPa. Please refer to the Articles: Yakobson et al., Phys. Rev. Lett. 1996, 76, 2411; Lourie et al., J. Mater. Res. 1998, 13, 2418; lijima et al., J. Chem. Phys. 1996, 104, 2089. Generally, CNT composites interpenetrating nanofiber networks, the networks comprising mutually entangled carbon nanotubes intertwined with macromolecules in a cross-linked polymer matrix. One of the methods to form the CNT is the infusion of organic molecules capable of penetrating into the clumps of tangled CNTs, thereby causing the nanotube networks to expand and resulting in exfoliation. Subsequent in situ polymerization and curing of the organic molecules generates interpenetrating networks of entangled CNTs or CNT nanofibers (ropes), intertwined with cross-linked macromolecules.

In one embodiment, the conductive polymer maybe made from at least one precursor monomer selected from thiophenes, selenophenes, tellurophenes, pyrroles, anilines, and polycyclic aromatics. The polymers made from these monomers are referred to herein as polythiophenes, poly(selenophenes), poly(tellurophenes), polypyrroles, polyanilines, and polycyclic aromatic polymers, respectively. U.S. Patent Application Publication No. US2008/0017852 to Huh; Dal Ho et al., entitled “Conductive Polymer Composition Comprising Organic Ionic Salt and Optoelectronic Device Using the Same”, discloses a method of forming a conductive polymer. In one embodiment, the conductive polymer is an organic polymer semiconductor, or an organic semiconductor. The conductive polyacetylenes type include polyacetylene itself as well as polypyrrole, polyaniline, and their derivatives. Conductive organic polymers often have extended delocalized bonds, these create a band structure similar to silicon, but with localized states. The zero-band gap conductive polymers may behave like metals.

Alternatively, the antenna can be formed of a conductive glue that can be made of material such as silicon glue or epoxy, etc. The thin film antenna is transparent. In one embodiment, the conductive glue may be formed of the mixture of at least one glass, additive and conductive particles (such as metallic particles). The conductive glue may also include aluminum (and/or silver) powder and a curing agent. The glass is selected from Al₂O₃, B₂O₃, SiO₂, Fe₂O₃, P₂O₅, TiO₂, B₂O₃/H₃BO₃/Na₂B₄O₇, PbO, MgO, Ga₂O₃, Li₂O, V₂O₅, ZnO₂, Na₂O, ZrO₂, TlO/Tl₂O₃/TlOH, NiO/Ni, MnO₂, CuO, AgO, Sc₂O₃, SrO, BaO, CaO, Ti and ZnO. The additive material includes oleic acid. The antenna pattern includes fractal antenna configuration, monopole, dipole antenna configuration, battlements shape, trapezoidal planar antenna configuration, and inverted F configuration. One of the inverted F structure may refer to U.S. Patent Application Publication No. US2008/0001826, filed on Jul. 3, 2007. However, the antenna is formed on a circuit board. It suffers the drawback mentioned above. The thin film antenna is formed on a surface of a portable device, surface of a vehicle, window of building, or for a NFC (near field contact-less) application, such as a NFC card.

As is understood by a person skilled in the art, the foregoing preferred embodiments of the present invention illustrate the present invention rather than limit the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

Having described the invention, the following is claimed:

1. An antenna comprising:
a conductive pattern having an antenna configuration;
wherein said conductive pattern is formed of conductive carbon, a conductive polymer or a conductive glue having glass and conductive particles.

2. The antenna of claim 1, wherein said conductive pattern includes one or more particles selected from Au, Zn, Ag, Pd, Pt, Rh, Ru, Cu, Fe, Ni, Co, Sn, Ti, In, Al, Ta, Ga, Ge and Sb.

3. The antenna of claim 1, wherein said conductive carbon includes carbon nanotubes (CNT).

4. The antenna of claim 1, wherein said conductive polymer includes polythiophenes, poly(selenophenes), poly(tellurophenes), polypyrroles or polyanilines.

5. The antenna of claim 1, wherein said conductive glue includes glass, conductive particles and an additive.

6. The antenna of claim 1, wherein said glass is selected from Al₂O₃, B₂O₃, SiO₂, Fe₂O₃, P₂O₅, TiO₂, B₂O₃/H₃BO₃/Na₂B₄O₇, PbO, MgO, Ga₂O₃, Li₂O, V₂O₅, ZnO₂, Na₂O, ZrO₂, TlO/Tl₂O₃/TlOH, NiO/Ni, MnO₂, CuO, AgO, Sc₂O₃, SrO, BaO, CaO, Tl and ZnO.

7. The antenna of claim 1, wherein said antenna pattern includes a fractal antenna configuration.

8. The antenna of claim 7, wherein said fractal antenna pattern includes a koch pattern or a Blackman-koch pattern, a lotus pods pattern, a Sierpinski pattern, a hexagonal pattern, or a polygonal pattern.

9. The antenna of claim 1, wherein said antenna pattern includes a stochastic pattern.

10. The antenna of claim 1, wherein said antenna pattern includes a monopole, a dipole or an invert F antenna configuration.

11. The antenna of claim 1, wherein said antenna pattern includes a battlements shape, or a trapezoidal planar antenna configuration.

12. The antenna of claim 1, wherein said antenna is formed on a surface of a portable device, a surface of a vehicle, a window of a building, or for a near field contact-less (NFC) application.

13. A film antenna having a set of geometry patterns of same basic elements, wherein said geometry pattern is formed of conductive carbon, a conductive polymer or a conductive glue having glass and conductive particles.

14. The antenna of claim 13, wherein said pattern includes one or more particles selected from Au, Zn, Ag, Pd, Pt, Rh, Ru, Cu, Fe, Ni, Co, Sn, Ti, In, Al, Ta, Ga, Ge and Sb.

15. The antenna of claim 13, wherein said conductive carbon includes carbon nanotubes (CNT).

16. The antenna of claim 13, wherein said conductive polymer includes polythiophenes, poly(selenophenes), poly(tellurophenes), polypyrroles, polyanilines.

17. The antenna of claim 13, wherein said conductive glue includes glass, conductive particles, and an additive.

18. The antenna of claim 13, wherein said glass is selected from Al₂O₃, B₂O₃, SiO₂, Fe₂O₃, P₂O₅, TiO₂, B₂O₃/H₃BO₃/Na₂B₄O₇, PbO, MgO, Ga₂O₃, Li₂O, V₂O₅, ZnO₂, Na₂O, ZrO₂, TlO/Tl₂O₃/TlOH, NiO/Ni, MnO₂, CuO, AgO, Sc₂O₃, SrO, BaO, CaO, Tl or ZnO.

19. The antenna of claim 13, wherein said antenna is formed on a surface of a portable device, a surface of a vehicle, a window of building, or for a near field contact-less (NFC) card

20. An antenna formed on an interior or exterior surface of a housing of a device having a printed circuit board, wherein a shielding structure is disposed between said antenna and said shielding structure; wherein said antenna comprises: a conductive pattern, said conductive pattern formed of a metallic material, conductive carbon, a conductive polymer or a conductive glue having glass and conductive particles.
